(19) United States
(12) Patent Application Publication
(10) Pub. No.: US 2025/0115727 A1
(43) Pub. Date: Apr. 10, 2025

(54) Multilayer Sealable Blown Film for Form-Fill-Seal Applications

(71) Applicant: Formosa Plastics Corporation, USA, Livingston, NJ (US)

(72) Inventors: Peng Li, Sugarland, TX (US); Ming-Yung Lee, Port Lavaca, TX (US); Honglan Lu, Port Lavaca, TX (US); Pete Vance, Port Lavaca, TX (US)

(21) Appl. No.: 18/983,488

(22) Filed: Dec. 17, 2024

Related U.S. Application Data
(63) Continuation of application No. 16/713,887, filed on Dec. 13, 2019.

(51) Int. Cl. B32B 27/32; B32B 27/08

(52) U.S. Cl. CPC C08J 5/18; B32B 1/08; B32B 27/08; B32B 27/32; B65B 9/00; C08L 23/06; C08L 23/16; B32B 2553/00; B32B 2597/00; C08J 2323/06; C08J 2323/16; C08J 2423/06; C08J 2423/16; C08L 2203/162; C08L 2205/025; C08L 2205/03; C08L 2207/062

(57) ABSTRACT

A multilayer blown film, designed for use in heavy duty sacks manufactured by a high-speed Form-Fill-Seal packaging process, having unique heat sealing characteristics and desirable mechanical properties is disclosed. Additionally, a multilayer blown film consists of skin layers prepared from a Ziegler-Natta catalyzed ethylene and alpha-olefin copolymer with novel composition distribution, and at least one core layer that includes both HPDE and LLDPE. The multilayer blown film, with no external sealing additives present in skin layers, exhibits outstanding processability, superior tear resistance, as well as balanced stiffness and toughness.

### BACKGROUND OF THE INVENTION

### 1. Field of Invention

The present invention relates to a blown film component layer for use in multilayer heat scalable films for high-speed Form-Fill-Seal (FSS) applications. In particular, the blown film component sealant layer is made from a novel Ziegler-Natta catalyzed LLDPE copolymer with inherently outstanding sealing properties and balanced mechanical performance.

### 2. Description of Related Art

Form-Fill-Seal (FFS) is one major technique used in the packaging industry for a variety of applications such as food, electronics, and medical packaging. The use of a variety of polyolefin to produce heat sealable films with good processability, excellent optical properties, balanced stiffness and toughness, in addition to a strong seal strength for ensuring package integrity, is well-known in the art. The entire heat sealed film may be constructed from the same polymer or a blend of polymers. In most cases, the films are constructed using layers of different polymeric materials, which are constructed to ensure that multilayer films have desirable physical and mechanical properties. In addition, such multilayer films must be easily processed by high speed packaging apparatus, which are commonly known as vertical and horizontal Form-fill-seal machines.

High speed Form-Fill-Seal (FFS) packaging systems are cost effective for bagging bulk products such as polyolefin pellets, chemicals, fertilizers and pet food, with a commercially available maximum capability of producing about 2400 bags per hour. The characteristics of multilayer films become significantly critical due to the high-speed requirements of the FFS system. The higher the speed of the FFS system, the more critical the characteristics of the film become. Various types of polyethylene polymers are known in the art as having acceptable heat scaling properties, e.g. linear low polyethylene (LLDPE), very low density polyethylene (VLDPE), low density polyethylene (LDPE), ethylene vinyl acetate (EVA), ethylene butyl acrylate (EBA), ethylene methyl acrylate (EMA), elastomer/plastomer, and high density polyethylene (HDPE). While these polymers can be used as the sealing layer alone, more often they are used as blends with other polymers within this group to achieve the desirable scaling and mechanical properties.

An optimum polyolefin resin composition for use as a sealing layer in heat scalable films for packaging and storage applications possess a number of key performance properties, such as relatively low heat seal initiation temperature, high hot tack strength, and a broad sealing window. Operating at low sealing temperatures is beneficial for efficient heat transfer in the sealant layer while the other layers of films are not exposed to high temperature. There are also economic advantages since low processing temperature can potentially improve sealing speed and reduce energy consumption. High hot tack strength and a broad sealing window are important, especially for FFS, for ensuring package integrity, scaling equipment flexibility, and low package leakage rate. In most cases, the seal of packaging bags is under stress, especially during the filling process, while it's warm before cooling. This means that hot tack properties of the sealing layer are crucial to provide the formation of sufficient seal strength before complete film crystallization. U.S. Pat. No. 7,018,710 discloses a sealant layer composition (produced by Metallocene catalysts in a slurry reactor system) comprising ethylene copolymer in which: (I) there are two distinct maxima in TREF fractogram—at least 10% of the ethylene copolymer composition elutes in TREF at a temperature of less than 50° C., and at least 25% of the ethylene copolymer composition elutes at a temperature of higher than 75° C.; (II) none of the ethylene composition elutes in TREF at a temperature of higher than 100° C.; (III) the ethylene copolymer composition comprises two components—one of which is of relatively high comonomer content and high molecular weight, the other of which is of relatively low comonomer content and low molecular weight, both components being prepared by polymerization of ethylene with a-olefin in the presence of a single-site catalyst; and (IV) the ethylene composition has a density of between 0.905 and 0.930 g/cc and a melt index between 0.3 and 4.0 g/10 min.

In the applications of heavy duty bags, U.S. Pat. No. 5,756,193 disclosed a film structure comprising blends of linear low polyethylene (LLDPE), linear medium density polyethylene (MDPE), or linear high density polyethylene (HDPE), and low density polyethylene (LDPE), which was reported to have better mechanical properties. Also good machinability like bag filling and palletization operation requires the film to have a certain minimum stiffness by increasing overall density or crystallinity. Increased density often leads to poor impact properties and seal rupture when a bag is dropped, especially in the weakest corner sealing area. Therefore, there exists a need for improved multilayer films and heavy duty sacks made therefrom that have balanced stiffness and toughness, outstanding machine direction tear resistance, as well as desirable scalability and machinability even when the packaging material is made/filled on high speed bagging equipment.

Adding additional heat sealing agents in skin layers is one common approach to improve heat sealing and hot tack performance of polyolefin heat sealable films. For example, U.S. Patent App. No. 2006/0188678 discloses LD150BW as external sealing agents in skin layers of heavy duty bag films. However, using an external sealing agent adds to the cost of the final product, or requires either preblending or alteration to production equipment to incorporate, either of which negatively impact its use. U.S. Patent App. No. 2019/0184690 discloses a multilayer film designed for Form-Fill-Seal applications. The sealant layer in multilayer films is formed from the blend of ZN-LLDPE with 20% LDPE or AFFINITY™ as external sealing additives. U.S. Pat. No. 5,530,065 discloses a sealing layer composition in the heat sealable film by blending at least one ethylene copolymer produced using a Metallocene catalyst system with a polymer having a narrow molecular weight distribution and at least one second ethylene copolymer produced using a Ziegler-Natta catalyst system with a polymer having a broad molecular weight distribution. The blend was made to have a desirable sealing strength evaluated by using a laboratory-scale impulse heat sealer. In another example, U.S. Pat. No. 5,874,139 discloses a multilayer structure containing an improved sealant layer and a polypropylene layer which is particularly useful as a flexible packaging film structure, wherein the sealant layer is made from the combination of a homogeneously branched ethylene copolymer such as AFFINITY™ having a density in the range of about 0.885 to 0.905 g/cc and a linear low density polyethylene (LLDPE) having a density in the range of about 0.91 to about 0.95 g/cc. The resulting sealant layer was said to have balanced sealing and mechanical properties. As another example of polyolefin sealant materials, TAFMER™ resins are known to provide sealants with relatively low seal initiation temperatures, however TAFMER™ resins are not known to provide the overall desirable mechanical performance (either as single component sealants or when used as polymer blend materials). Also, TAFMER™ resins are considered to be relatively expensive. As discussed herein, the present invention does not use external sealing agent additives as used in these prior art multilayer films.

As such, there is a need for a unique LLDPE-based blown film sealant component layer for the use in high-speed Form-Fill-Seal (FFS) applications, which would inherently exhibit an outstanding hot tack and heat scaling properties, good processability with low hexane extractables, and desirable mechanical properties such as balanced toughness and stiffness. Importantly, no external scaling additives are present in the skin layer of the multilayer films disclosed herein.

### SUMMARY OF THE INVENTION

The present invention provides a multilayer blown film comprising unique LLDPE-based sealant layers with inherently outstanding sealing characteristics and balanced mechanical properties, which is designed for use in the manufacture of heavy duty bags. In accordance with an embodiment of the invention, the multilayer blown films consist of skin layers comprising a Ziegler-Natta catalyzed LLDPE copolymer with a novel composition distribution, and at least one core layer prepared from different plastic resins such as linear low density polyethylene (LLDPE), medium density polyethylene (MDPE), and high density polyethylene (HDPE).

In one embodiment, the sealant component layer in multilayer films of this invention is made from a novel LLDPE copolymer having a unique composition distribution and distinctive molecular structure. The LLDPE resin of the present invention exhibits uniform comonomer distribution across its entire molecular weight, in which comonomers are evenly incorporated into the high molecular weight polymer chains. The resin of this invention has at least 15 wt % of the ethylene copolymer components eluted in TREF at a temperature of lower than 35° C. The molecular weight (Mw) of the inventive copolymer resin is substantially constant over the entire TREF fraction distribution. The resin of this invention being prepared with C3 to C8 alpha-olefins has a controlled molecular weight distribution (Mw/Mn) of 2.5-8.0, a melt index of between 0.5 and 5 dg/min, and a density of between 0.910 and 0.930 g/cc. The copolymer is produced by reacting ethylene and an alpha-olefin comonomer in the presence of titanium-based Ziegler-Natta catalyst in a gas phase reactor process in the range of about 50° C. to about 100° C.

In another embodiment, the multilayer films according to the formulation of the present invention are fabricated by means of various conversion processes, including but not limited to a three-layer blown film extrusion. In addition, the inventive films, with no additional scaling additives present in skin layers, have been evaluated by at least 2000 bag/hr of high-speed FFS system showing good mechanical integrity and desirable machinability.

In yet another embodiment, the multilayer blown films have outstanding heat sealing and hot tack properties, outstanding processability, as well as desirable mechanical properties is disclosed. Additionally, a multilayer blown film utilizing a blown film component layer prepared from a Ziegler-Natta catalyzed ethylene and alpha-olefin copolymer is disclosed, wherein the blown film shows a MD yield strength of greater than 1800 psi, a MD modulus of greater than 35 kpsi, a dart resistance of at least 120 g/mil, and a TD tear resistance of greater than 500 g/mil. Importantly, no additional heat scaling additives are present in the heat scalable skin layers of the inventive multilayer blown films.

### BRIEF DESCRIPTION OF THE FIGURES

The features and advantages of the present invention will be more clearly understood from the following description taken in conjunction with the accompanying drawings in which:

FIG. 1 is an exemplary TREF distribution of Ziegler-Natta catalyzed ethylene and alpha-olefin copolymer, in accordance with certain teachings of the present invention.

FIG. 2 shows exemplary GPC results of a LLDPE resin and its TREF 35° C. soluble fraction, in accordance with certain teachings of the present invention.

FIG. 3 depicts a cross-sectional structural view of an exemplary multilayer blown film of the present invention

FIG. 4 depicts exemplary heat sealing strength (N) and hot tack strength (N) for an exemplary multilayer blown film of the present invention

FIG. 5 depicts a star chart illustrating the physical properties of an exemplary multilayer blown film of the present invention

### DETAILED DESCRIPTION

The present invention relates to the production of advanced Ziegler-Natta catalyzed LLDPE used as a heat scalable blown film component layer with a novel composition distribution. The LLDPE resins used in the present invention are preferably prepared using the advanced Ziegler-Natta catalyst in a gas-phase fluidized bed reactor. The heat sealable multilayer films comprising the skin layers prepared from the novel LLDPE copolymer of this invention provide desirable performance with no external sealing agent for use in high-speed Form-Fill-Seal (FFS) applications.

### Catalyst System and Polymerization Process

The catalyst utilized herein is an advanced Ziegler-Natta catalyst modified with non-single-site catalyst ligands and/or interior with a strong Lewis base such as aromatic compounds containing a nitrogen atom. Examples of such catalyst are described in U.S. Pat. Nos. 6,992,034 and 7,618,913, which are incorporated by reference in their entireties herein.

The ethylene and alpha-olefin LLDPE copolymer of this invention was produced in a commercial BP gas phase polymerization process. The ethylene copolymers prepared in accordance with the present invention may be copolymers of ethylene with one or more C₃-C₁₀ alpha-olefins. The preferred co-monomers include 4-methyl-1-pentene, 1-hexene, 1-octene and 1-butene for the catalyst prepared according to the present invention. Typically in a gas phase polymerization process a continuous cycle is employed wherein one part of the cycle of a reactor system, a cycling gas stream, otherwise known as a recycle stream or fluidizing medium, is heated in the reactor by the heat of polymerization. This heat is removed from the recycle composition in another part of the cycle by a cooling system external to the reactor. Generally, in a gas fluidized bed process for producing polymers, a gaseous stream containing one or more monomers in continuously cycled through a fluidized bed in the presence of a catalyst or prepolymer under reactive conditions. The gaseous stream is withdrawn from the fluidized bed and recycled back into the reactor. Simultaneously, polymer product is withdrawn from the reactor and fresh monomer is added to replace the polymerized monomer.

The ethylene partial pressure should vary between 10 and 250 psia, preferably between 65 and 150 psia, more preferably between 75 and 140 psia, and most preferably between 90 and 120 psia. More importantly, a ratio of comonomer to ethylene in the gas phase should vary from 0.0 to 0.50, preferably between 0.005 and 0.25, more preferably between 0.05 and 0.20, and most preferably between 0.10 and 0.15. Reactor pressure typically varies from 100 psig to 500 psig. In one aspect, the reactor pressure is maintained within the range of from 200 psig to 500 psig. In another aspect, the reactor pressure is maintained within the range of from 250 psig to 350 psig.

The molecular weight of the copolymers may be controlled in a known manner, preferably by using hydrogen. With the catalysts produced according to the present invention, molecular weight may be suitably controlled with hydrogen when the polymerization is carried out at temperatures from about 20° C. to about 300° C. This control of molecular weight may be evidenced by a measurable positive change of the melting index (I₂). The molecular weight distribution (MWD) of the polymers prepared in the presence of the catalysts of the present invention, as expressed by the MFR values, varies from about 10 to about 40. MFR is the ratio of the high-load melt index (HLMI or I₂₁) to the melt index (MI or I₂) for a given resin (MFR=121/12). The ethylene/1-hexene copolymer having a density of 0.910 g/cc to 0.930 g/cc, in a preferred embodiment, have a melt index ratio (I₂₁/I₂) of from greater than about 20 to less than about 30. Copolymer resins produced in accordance with the present invention preferably contain at least about 75 percent by weight of ethylene units. Most preferably, the copolymer resins of the invention contain at least 0.5 weight percent, for example from 0.5 to 25 weight percent of an alpha-olefin.

### Multilayer Blown Film Structure and Composition

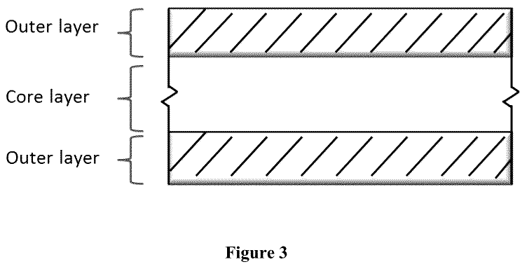

The multilayer films of the present invention are typically fabricated by the blown film processes. FIG. 3 shows a cross-sectional view of multilayer blown film structure of the present invention. The multilayer blown films include film constructions represented by, for example, 3-layer structure A/B/C, where the A and C sealant layers may be the same or different resin composition, at least one of which is made from the LLDPE copolymer of this invention, and the B is a blend of HDPE and LLDPE. In another example of 5-layer film construction A/D/B/D/C, where the A and C sealant layers may be the same or different resin composition at least one of which is made from the LLDPE copolymer of this invention, and the D and B core layers may be the same or different resin composition, at least one core layer of which is a blend of HDPE and LLDPE selected for specific end-use properties. Additionally, the films may be represented as A/D/B/B/B/D/C, or the like, where the same letter represents a layer of the same composition.

The multilayer blown film of the present invention comprises two outer or sealant layers. For acceptable heat sealable film performance, it is expected that at least one outer layer has desirable sealing characteristics allowing it to seal with good mechanical integrity when applied to high-speed sealing conditions on the commercial-scale manufacture. The use of polyethylene copolymers in the outermost layers for scaling function is well-known in the art.

Suitable polyethylene resins for sealing use include conventional linear low density polyethylene (LLDPE), ultralow density polyethylene (ULDPE), and media density polyethylene (MDPE) which could be homopolymers, copolymers, or terpolymers, of ethylene and alpha-olefins. In copolymers, the weight percentage of the alpha-olefins is about 4 to 15% by weight, preferably from 6 to 12% by weight. Applicable alpha-olefin comonomers include propylene, 1-butene, 1-pentene, 1-hexene, 4-methyl-pentene, and 1-octene. The alpha-olefins range from about C3 to C20, preferably C3 to C10, more preferably from C3 to C8. The resin melt index will typically be between 0.2 and 10 dg/min, preferably between 1 and 5 dg/min, and more preferably between 1 and 2 dg/min. Resin density will be between 0.860 and 0.940 g/cc, preferably between 0.900 and 0.930 g/cc. If the LLDPE resins contain hexane extractables, it's desirable that hexane extractable levels is below approximately 4 weight percent to minimize potential for film blocking, high unwind noise, roll telescoping, roll softness and die build-up.

Thermal heating is utilized to activate a sealant layer comprised of a heat sealable material, usually a polymeric material. The temperature required to activate the heat sealable material and formed a durable seal is termed as the seal initiation temperature (SIT). The ability of the seal to resist opening immediately after being formed is termed as hot tack. The temperature range over which a durable seal can be formed and maintained is termed as the hot tack window while the strength of seal formed is termed as the heat seal strength. An optimum polyolefin resin composition for use as a sealing layer in heat scalable films for packaging and storage applications would possess a number of key performance properties such as relatively low heat seal initiation temperature, high hot tack strength and a broad scaling window.

The multilayer blown film of the present invention comprises two outer layers, with no sealing additives present, made from a Ziegler-Natta catalyzed LLDPE copolymer with a novel molecular composition. The novel ethylene copolymer is produced by reacting ethylene and an alpha-olefin comonomer in the presence of a titanium-based Ziegler-Natta catalyst in a gas-phase process at reaction temperatures in the range of about 50° C. to about 100° C. Such ethylene copolymer resins possess unique composition distribution and distinctive molecular structure.

The LLDPE copolymer of the present invention exhibits uniform comonomer distribution across its entire molecular weight in which comonomers are evenly incorporated into the high molecular weight polymer chains. The resin of this invention has at least 15 wt % of the ethylene copolymer components eluted in TREF at a temperature of lower than 35° C. The molecular weight (Mw) of the inventive copolymer resin is substantially constant over entire FREF fraction distribution. The resin of this invention being prepared with C3 to C8 alpha-olefins composition has a controlled molecular weight distribution (Mw/Mn) of 2.5-5.0, a melt index of between 0.5 and 5 dg/min, and a density of between 0.910 and 0.930 g/cc. The unique resin molecular architecture profile could be potentially beneficial features in various applications such as high-speed Form-Fill-Seal (FFS) processes.

The LLDPE copolymer of this invention was polymerized by using an advanced Ziegler-Natta catalyst modified with non-single-site catalyst ligands and/or interior with a strong Lewis base such as aromatic compounds containing a nitrogen atom. The alpha-olefin comonomer is selected from 1-hexene and 1-butene. Typically, ethylene and other alpha-olefins are copolymerized in a gas phase polymerization process in the presence of a titanium-based Ziegler-Natta catalyst and an alkyl-aluminum co-catalyst at an ethylene partial pressure of from 10 psia to 350 psi, and a comonomer to ethylene ratio of 0.01 to 0.50. Examples of such catalyst and polymerization conditions are described in U.S. Pat. Nos. 6,992,034 and 7,618,913, which are incorporated by reference herein.

The hexane extractable of the resin of this invention is less than about 2.5 wt %, which is a beneficial feature for processability in film extrusion. Concerns for having high hexane extractable containing polymers in the outermost layers exist because the high hexane extractables are believed to contribute the problem of die build-up during extrusion and a build-up of low molecular weight olefinic material on fabrication equipment. A build-up of low molecular weight olefinic material is undesirable because the film surface may be negatively affected during film extrusion which may results in inconsistency in film physical performance. In a preferred embodiment of the invention, no sealing agents with high hexane extractables are present to achieve desirable sealing performance of multilayer blown films.

The inner layers of the inventive multilayer films are designed to provide desirable mechanical properties which is critical to heavy-duty-bag applications. Suitable polyethylene resins with outstanding strength, either homopolymers or copolymers, include but not limited to conventional linear low density polyethylene (LLDPE), media density polyethylene (MDPE), Metallocene catalyzed linear low density polyethylene (mLLDPE), and high density polyethylene (HDPE). In copolymers, the weight percentage of the alpha-olefins is about 4 to 15% by weight, preferably from 6 to 12% by weight. Applicable alpha-olefin comonomers include propylene, 1-butene, 1-pentene, 1-hexene, 4-methyl-pentene, and 1-octene. The alpha-olefins range from about C3 to C20, preferably C3 to C10, more preferably from C3 to C8. The resin melt index will typically be between 0.2 and 10 dg/min, preferably between 1 and 5 dg/min, and more preferably between 1 and 2 dg/min. Resin density will be between 0.860 and 0.946 g/cc, preferably between 0.900 and 0.930 g/cc.

The inner layer of the multilayer film of the present invention provides a blend of HDPE and LLDPE, comprising 20% to 80% by weight of HDPE and 20% to 80% by weight of LLDPE, more preferably 30% to 70% by weight of HDPE and 30% to 70% by weight of LLDPE. The LLDPE copolymer composition in outer layers and inner layers of the multilayer blown films may be same or different. The thickness of the multilayer film of the present invention is at least about 4 mil. The thickness ratio of the inner layer over the total film thickness is in the range of about 20% to about 80%, more preferably in the range of about 30% to about 70%.

Melt flow ratio, which is the ratio of high melt flow index (HLMI) to melt flow index (MI) was used as a measure of melt fluidity and a measure of the molecular weight distribution of polymers. The melt flow ratio is believed to be an indication of the molecular weight distribution of the polymer, the high the value, the broader the molecular weight distribution. Composition distribution or short chain branching distribution of polymers, and comonomer content, and molecular weight in each fractionated fraction were determined by TREF and GPC-FTIR with a solvent of TCB. All molecular weight are weight average molecular weight unless otherwise noted. Molecular weights including weight average molecular weight (Mw), number average molecular weight (Mn), and (Mz) were measured by Gel Permeation Chromatography (GPC).

### Blown Film Extrusion and Physical Properties

The multilayer films of the present invention are typically produced by the conventional blown film process. The polymers according to the formulation of the present invention are easily extruded into multilayer blown films. The gauge of the films of interest here can be in the range of about 3 mil to about 10 mil, preferably from about 4 mil to about 8 mil, and more preferably in the range of about 4 mil to about 6 mil. Examples of various extruders with a blown film die, air ring, and continuous take off equipment, including but not limited to Reifenhauser blown film line and LabTech blown film line, which can be used in producing the films of the present invention.

Heat sealable films made according to certain teachings of the present invention were fully evaluated with comparison to a commercially available control sample. Heat sealing and hot tack properties were tested by B&J hot tack machine. Heat sealing properties were tested under the condition of 200 mm/s clamp separation speed, 1 inch film specimen width, 5 mm by 50 mm seal bar size, 0.3 N/mm² bar pressure, and 0.5 sec dwell time. 30 sec cooling time is used for heat sealing test while hot tack is tested with 0.2 sec cooling time. Great care has been taken for proper specimen preparation with achieving an average value after taking five measurements.

Mechanical properties of the inventive multilayer films have been evaluated based on ASTM standards. Tensile measurements were made according to ASTM D882. Film tear resistance was tested according to ASTM D1922. Film dart impact was measured according to ASTM D1709.

Film surface properties have also been tested which is critical to the palletization process of heavy-duty-bags. Coefficient of friction (COF) of films was evaluated by both dynamic and static method according to ASTM D1894.

Form-Fill-Seal (FFS) packaging systems are cost effective for bagging bulk products such as polyolefin pellets, chemicals, fertilizers and pet food. To improve the economics and competitiveness of the FFS system, high speed machines have been developed with maximum capability of producing faster than 2000 bags per hour. The inventive films have been evaluated by high-speed Form-Fill-Seal (FFS) system provided by WINDMOLLER & HOLSCHER (W&H).

### Examples

In order to provide a better understanding of the foregoing discussion, the following non-limiting examples are offered. Although the examples may be directed to specific embodiments, they are not to be viewed as limiting the invention in any specific respect.

Melt flow index (MI) of the polymer was measured at 190° C. according to ASTM D1238. Density was measured according to ASTM D1505. All molecular weights are weight average molecular weight unless others noted. Molecular weights (weight average molecular weight (Mw), number average molecular weight (Mn), and (Mz) were measured by Gel Permeation Chromatography (GPC). Composition distribution or short chain branching of polymers, and comonomer content and molecular weight in each fractionated fraction were determined by Temperature Raising Elusion Fraction (TREF) and GPC-FTIR at a high temperature of 145° C., flow rate of 0.9 mL/min, solvent of TCB, and the concentration of solution of 2.5 mg/Ml.

The ethylene/1-hexene copolymers of this invention for the manufacture of multilayer films were produced with modified Ziegler-Natta catalysts in a gas-phase fluidized bed reactor. More detailed resin polymerization information is described in our U.S. Pat. Nos. 8,993,693 B2 and 6,992,034 B2, which are incorporated in the entireties herein.

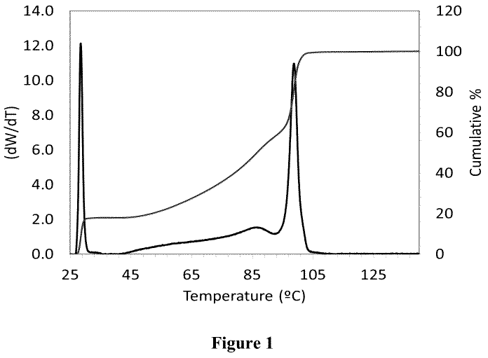

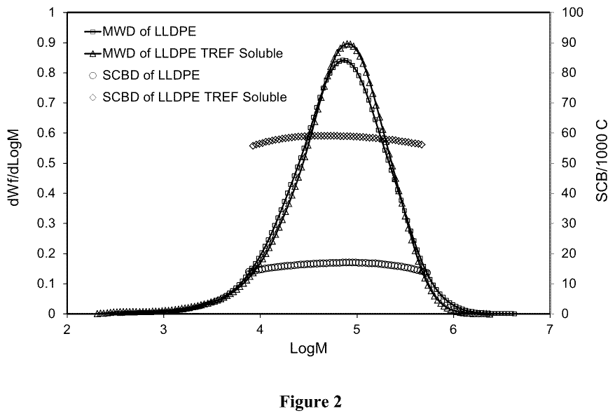

The distribution of the short chain branches have been characterized by using both GPC and Temperature Rising Elution Fractionation (TREF), especially to determine the molecular architecture of the resin eluted form the TREF column at a given low temperature. TREF results in FIG. 1 indicate that the resins of the present invention exhibit a content of TREF fraction eluted at low temperature of 35° C. is as high as 18%, which is noticeably different from that of mLLDPE. Moreover, the molecular weight (Mw) of the TREF soluble fraction was found to be comparable over the entire TREF fraction distribution. Short chain branching distribution (SCBD) of the copolymer of this invention is shown in FIG. 2. The copolymer has a novel composition distribution in which commoners are incorporated into the high molecular weight polymer molecules and distributed relatively evenly among the entire polyethylene chains with substantial absence of low molecular weight polymer molecules. The LLDPE copolymers of this invention exhibit a global composition distribution, which differs from the broad composition distribution of conventional ZN-LLDPE resins.

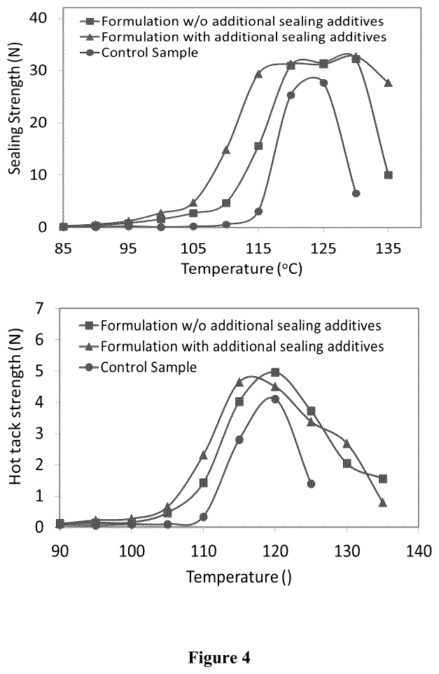

In one example of the present invention, a three-layer blown film having a layer configuration of A/B/A, with relative layer compositions of 30/40/30 parts by thickness as shown in FIG. 4. The inventive films were extruded by using multilayer blown film lines. Component A is the Ziegler-Natta catalyzed hexene-copolymer LLDPE of the present invention with ˜1.0 g/10 mins o melt index, and ˜0.925 g/cc density. Component B is a blending of LLDPE and HDPE with a preferred blending recipe of approximately 50% HDPE by weight. The Formosa Plastics Company, FORMAX® LLDPE is a LLDPE resin with a density of about 0.921 g/cc and a melt index of 1.0 g/10 mins which is commercially available from Formosa Plastics Company. The HDPE resin in Table 1 has a HLMI in the range of 6-10 g/10 mins, and a density between about 0.940 g/cc and about 0.950 g/cc. AFFIITY® is a plastomer polyethylene copolymer which is commercially available from Dow Chemical company. Marlex® D143 is Metallocene linear low density polyethylene which is commercially available from Chevron Phillips Chemical Company. The multilayer blown film extrusion conditions and physical properties are summarized in Table 1 and Table 2 below.

TABLE 1

| | Outer layer | Inner layer | Outer layer | Layer | Output |
|---|---|---|---|---|---|
| Example | (1st layer) | (2nd layer) | (3rd layer) | ratio | (lb/hr) |
| #1 | 100% FORMAX ® LLD | 100% FORMAX ® LLD | 100% FORMAX ® LLD | 2:1:2 | 15 |
| #2 | 70% FORMAX ® | 100% FORMAX ® LLD | 70% FORMAX ® LLD + | 2:1:2 | 15 |
| | LLD + 30% HDPE | | 30% HDPE | | |
| #3 | 65% FORMAX ® LLD + | 100% FORMAX ® LLD | 65% FORMAX ® LLD + | 2:1:2 | 15 |
| | 25% HDPE + 10% | | 25% HDPE + 10% | | |
| | Affinity ® | | Affinity ® | | |
| #4 | 100% FORMAX ® LLD | 70% FORMAX ® LLD + | 100% FORMAX ® LLD | 3:4:3 | 15 |
| | | 30% HDPE | | | |
| #5 | 90% FORMAX ® LLD + | 70% FORMAX ® LLD + | 90% FORMAX ® LLD + | 3:4:3 | 15 |
| | 10% Affinity ® | 30% HDPE | 10% Affinity ® | | |
| #6 | 100% FORMAX ® LLD | 70% FORMAX ® LLD + | 100% FORMAX ® LLD | 1:3:1 | 15 |
| | | 30% HDPE | | | |
| #7 | 90% FORMAX ® LLD + | 70% FORMAX ® LLD + | 90% FORMAX ® LLD + | 1:3:1 | 15 |
| | 10% Affinity ® | 30% HDPE | 10% Affinity ® | | |
| #8 | 100% FORMAX ® LLD | 70% FORMAX ® LLD + | 100% FORMAX ® LLD | 3:4:3 | 500 |
| | | 30% HDPE | | | |
| #9 | 75% FORMAX ® LLD + | 70% FORMAX ® | 75% FORMAX ® LLD + | 3:4:3 | 500 |
| | 25% D143 | LLD + 30% HDPE | 25% D143 | | |
| #10 | 100% FORMAX ® LLD | 50% FORMAX ® | 100% FORMAX ® LLD | 3.5:3:3.5 | 500 |
| | | LLD + 50% HDPE | | | |
| #11 | 100% FORMAX ® LLD | 50% FORMAX ® | 100% FORMAX ® LLD | 3:4:3 | 500 |
| | | LLD + 50% HDPE | | | |
| #12 | 100% FORMAX ® LLD | 50% FORMAX ® | 100% FORMAX ® LLD | 2.5:5:2.5 | 500 |
| | | LLD + 50% HDPE | | | |

TABLE 2
Properties of 3-layer Blown Films

| | | Example | Example | Example | Example | Example | Example | Example |
|---|---|---|---|---|---|---|---|---|
| Testing Items | ASTM | #1 | #2 | #3 | #4 | #5 | #6 | #7 |
| Tens. Str. @Brk-MD | D882 | 5622 | 5328 | 5349 | 5670 | 5503 | 5384 | 5539 |
| (psi) | | | | | | | | |
| Tens. Str. @Brk-TD | D882 | 5196 | 5273 | 5712 | 5280 | 4521 | 4908 | 5279 |
| (psi) | | | | | | | | |
| Elon. @Brk-MD (%) | D882 | 950 | 934 | 911 | 983 | 981 | 919 | 928 |
| Elon. @Brk-TD (%) | D882 | 1014 | 990 | 1014 | 1010 | 955 | 978 | 982 |
| Yield Stress-MD (psi) | D882 | 1546 | 1938 | 1808 | 1825 | 1765 | 1866 | 1809 |
| Yield Stress-TD (psi) | D882 | 1517 | 2069 | 1940 | 1771 | 1652 | 1693 | 1749 |
| Sec. Modulus-MD(psi) | D882 | 21965 | 35540 | 34028 | 28936 | 26001 | 28980 | 26304 |
| Sec. Modulus-TD (psi) | D882 | 24395 | 52252 | 45008 | 42462 | 40936 | 41265 | 41832 |
| Dart Impact (g) | D1709 | 1162 | 840 | 890 | 897 | 876 | 616 | 610 |
| Puncture max. load | — | 13.4 | 13.3 | 12.8 | 14.5 | 14.1 | 13.4 | 14.3 |
| (N/mil) | | | | | | | | |

| | | |
|---|---|---|
| Tear- (MD/TD) (g) | D1922 | >2000 (MD); >3000(TD) |

TABLE 3
Process Conditions of LabTech 3-layer Blown Film Line

| | | Screw | Melting | Melting | Motor |
|---|---|---|---|---|---|
| | | speed | Pressure | Temperature | Load |
| Extrusion | Layers | (rpm) | (psi) | (° F.) | (amps) |
| Example #1 | 1st layer | 68 | 7598 | 374 | 67 |
| | 2nd layer | 34 | 5439 | 374 | 54 |
| | 3rd layer | 68 | 7202 | 373 | 65 |
| Example #2 | 1st layer | 66 | 7760 | 372 | 64 |
| | 2nd layer | 33 | 5354 | 373 | 54 |
| | 3rd layer | 66 | 7383 | 372 | 63 |
| Example #3 | 1st layer | 66 | 7335 | 372 | 65 |
| | 2nd layer | 33 | 5260 | 372 | 53 |
| | 3rd layer | 66 | 6903 | 372 | 63 |
| Example #4 | 1st layer | 48 | 6066 | 355 | 63 |
| | 2nd layer | 71 | 7845 | 392 | 63 |
| | 3rd layer | 48 | 5350 | 351 | 60 |
| Example #5 | 1st layer | 48 | 5885 | 355 | 63 |
| | 2nd layer | 71 | 7814 | 392 | 63 |
| | 3rd layer | 78 | 5129 | 352 | 58 |
| Example #6 | 1st layer | 26 | 3379 | 362 | 51 |
| | 2nd layer | 78 | 7753 | 357 | 64 |
| | 3rd layer | 26 | 3304 | 351 | 49 |
| Example #7 | 1st layer | 26 | 3778 | 360 | 53 |
| | 2nd layer | 78 | 7745 | 371 | 61 |
| | 3rd layer | 26 | 3738 | 351 | 50 |

Note:
70 mm die size, 90 mil die gap, 15 lb/hr output and 2.0 BUR

TABLE 4
Properties of 3-layer Blown Films

| | | Comparative | Example | Example | Example | Example | Example |
|---|---|---|---|---|---|---|---|
| Testing Items | ASTM | Example #C4 | #8 | #9 | #10 | #11 | #12 |
| Tens. Str. @Brk-MD | D882 | 5598 | 5930 | 6000 | 5200 | 5354 | 5619 |
| (psi) | | | | | | | |
| Tens. Str. @Brk-TD | D882 | 4865 | 4980 | 5350 | 4610 | 4638 | 4742 |
| (psi) | | | | | | | |
| Elon. @Brk-MD (%) | D882 | 888 | 1043 | 1023 | 976 | 943 | 894 |
| Elon. @Brk-TD (%) | D882 | 875 | 1089 | 1082 | 1076 | 968 | 984 |
| Yield Stress-MD(psi) | D882 | 1925 | 1740 | 1730 | 1810 | 1916 | 2036 |
| Yield Stress-TD (psi) | D882 | 1943 | 1720 | 1830 | 1840 | 2141 | 2203 |
| Dart Impact (g) | D1709 | 950 | 987 | 867 | 620 | 720 | 538 |
| Sec. E (MD) (psi) | D882 | 37701 | 28382 | 27109 | 32591 | 36487 | 33002 |
| Sec. E (TD) (psi) | D882 | 44432 | 40316 | 36791 | 44260 | 47624 | 54955 |
| Tear- (MD) (g) | D1922 | 1541 | 2386 | 2587 | 2100 | 2400 | — |
| Tear -TD (g) | D1922 | 2837 | 3064 | 3313 | 3015 | 3275 | — |

| | | | | | |
|---|---|---|---|---|---|
| COF | D1894 | ~0.5 | 0.88 (static) | 0.80 (static) | 0.65-0.70 (static) |
| | | | 0.84 (kinetic) | 0.73 (kinetic) | 0.53-0.60 (kinetic) |

Reifenhauser 3-layer Blown Film Line: 175 mm die size, 90 mil die gap, 2.0 BUR, and 500 lb/hr output

Table 1 and Table 3 summarized the detailed processing conditions of 3-layer blown films in terms of screw speed, melting pressure, melting temperature and motor load. 3-layer blown films were manufactured by Lab-Tech blown film line with 70 mm of die diameter, 90 mil of die gap, and 2.0 of BUR. The blown films with a thickness in the range of 5.0-5.5 mil were successfully manufactured without any processability issues observed.

The multilayer blown film physical properties have been tested according to ASTM procedures. As is demonstrated in the Table 2 and Table 4, the films of the present invention exhibits desirable physical properties such as balanced stiffness and dart impact as well as superior MD tear resistance in additional to good processability. Comparative Example C4 is a commercial ZN-LLDPE based blown film with a thickness of ˜6 mil, which is designed for heavy duty bags used for polyolefin pellets packaging. The multilayer films of the present invention exhibit excellent mechanical properties in term of desirable MD/TD tensile yield strength, a dart resistance of at least about 120 g/mil, a MD tear strength of at least about 400 g/mil, and a MD modulus of at least 35 kpsi.

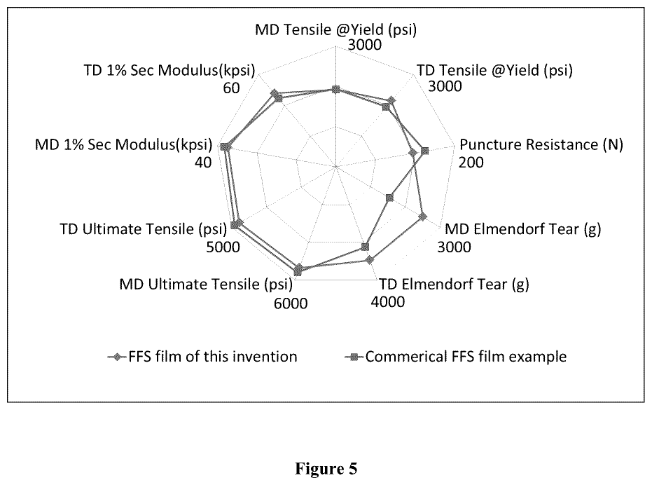

As demonstrated by our heat sealing results in FIG. 5, the 3-layer films made according to the invention, with no external sealing additives present in skin layers, have broader sealing window while maintaining comparable/slightly better sealing strength than commercially available FFS film sample (C4). The inventive films have been developed by taking advantage of unique sealing characteristics of LLDPE resin of this invention with desirable film performance, which is critical to high-speed FFS process.

The inventive 3-layer films have been evaluated by high-speed Form-Fill-Seal (FFS) system designed by W&H. The multilayer films successfully meet the processing requirements of the high-speed FFS system at packaging speed of faster than 2000 bags/hr. Moreover, the heavy-duty-bags made with the inventive films having bag width of 32 to 42 cm, bag length of 60 to 95 cm, and side gusset depth of 7 to 9 cm successfully passed hand drop tests without ruptured bags showing good mechanical integrity.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings therein. Furthermore, no limitations are intended to the details of construction or design herein shown, other than as described in the claims below. It is therefore evident that the particular illustrative embodiments disclosed above may be altered or modified and all such variations are considered within the scope and sprit of the present invention. Unless otherwise indicated, all numbers expressing quantities of ingredients, properties, reaction conditions, and so forth, used in the specification and claims are to be understood as approximations based on the desired properties sought to be obtained by the present invention, and the error of measurement, etc., and should at least be construed in light of the number of reported significant digits and by applying ordinary rounding techniques. Whenever a numerical range with a lower limit and an upper limit is disclosed, and number falling within the range is specifically disclose. Moreover, the indefinite articles “a” or “an”, as use in the claims, are defined herein to mean one or more than one of the element that it introduces.

What is claimed is:

1. A multilayer blown film for use in high-speed Form-Fill-Seal applications, comprising:
two outer layers prepared from titanium-based Ziegler-Natta catalyzed ethylene and C3 to C8 alpha-olefin copolymer, wherein the copolymer has at least 15% of Temperature Raising Elusion Fraction (TREF) soluble fraction below an elution temperature of 35° C.; wherein the molecular weight (Mw) of the copolymer is substantially constant over the entire TREF fraction distribution; wherein the Mw of the copolymer satisfies the formula: (Mw of 100° C.)/(Mw of 35° C.)=1.0 to 1.5; and wherein the copolymer has a relatively uniform comonomer distribution across its molecular weight; and
at least one inner layer comprising a blend of linear low density polyethylene (LLDPE) and high density polyethylene (HDPE) resins.

2. The film of claim 1, wherein the density of the outer layers is between about 0.910 g/cc and about 0.930 g/cc.

3. The film of claim 1, wherein the hexane extractables of the outer layers is less than about 3.5 wt %.

4. The film of claim 1, wherein the melt index (I₂) of the outer layers is between about 0.5 and about 5 dg/min.

5. The film of claim 1, wherein the melt index ratio (I21/I2) of the outer layers is between about 20 and about 35 dg/min.

6. The film of claim 1, wherein the polydispersity index (Mw/Mn) of the outer layers is between about 3.0 and about 5.0.

7. The film of claim 1, wherein no sealing additives are present in the outer layers.

8. The film of claim 1, wherein the at least one inner layers has a thickness ratio of 10 to 90% of the total thickness of the film.

9. The film of claim 1, wherein the LLDPE content in the at least one inner layer is from about 20% to about 80% by weight.

10. The film of claim 1, wherein the alpha-olefin comonomer is selected from 1-hexene, 1-octene, and 1-butene.

11. The film of claim 1, wherein the titanium-based Ziegler-Natta catalyst comprises:
a. magnesium;
b. a compound having the formula R¹ₘSi(OR²)ₙ, wherein R¹ and R² are C₁-C₂₀ carbon atoms, m=0-3, n=1-4, and m+n=4, and wherein each R¹ and each R² may be the same or different;
c. a compound having the formula R³ₓSiX_{y}, wherein R³ is C₁-C₂₀ carbon atoms, X is halogen, x=0-3, y=1-4, and x+y=4, and wherein each X and each R³ may be the same or different;
d. a compound having the formula MX₄ and M(OR⁴)X₄, wherein M is a titanium, wherein R⁴ is C₁-C₂₀ carbon atoms, X is halogen, and wherein each R⁴ may be the same or different;
e. a substituted aromatic nitrogen compound; and
f. an alkyl halide or aromatic halide compound having the formula R⁵X, wherein R⁵ is an alkyl group containing 3 to 20 carbon atoms or an aromatic group containing 6 to 18 carbon atoms, and X is selected from chlorine and bromine.

12. The film of claim 1, wherein the TREF soluble fraction eluted at 35° C. has at least 25 wt % comonomer compositions, and a polydispersity index (Mw/Mn) of between 3.0 and 5.0.

13. The film of claim 1, wherein the film has a MD tear strength of at least about 400 g/mil, and a TD tear strength of at least about 500 g/mil as determined by ASTM D1922.

14. The film of claim 1, wherein the film has a dart impact of at least 120 g/mil as measured according to ASTM D1709.

15. The film of claim 1, wherein the film has a MD yield strength of at least about 1800 psi, and a TD yield strength of at least about 1900 psi as determined by ASTM D882.

16. The film of claim 1, wherein the film has a MD Sec. modulus of at least about 35 kpsi, and a TD Sec. modulus of at least about 45 kpsi as determined by ASTM D882.

17. A method for manufacturing a heavy duty sack, comprising:
Providing a multilayer blown film according to claims 1-16, wherein the film has a film thickness of between about 3 mil to about 6 mil;
Manufacturing the heavy duty sacks from the multilayer blown film using a high speed Form-Fill-Seal packaging process.
